(19) United States
(12) Patent Application Publication
(10) Pub. No.: US 2015/0067736 A1
(43) Pub. Date: Mar. 5, 2015

(54) Systems and Methods of Notification of Duplicate Content Available Elsewhere

(71) Applicant: COX COMMUNICATIONS, INC., Atlanta, GA (US)

(72) Inventors: Robert Clark Whitten, Kennesaw, GA (US); Ronald Larry Hardzog, JR., Sapulpa, OK (US)

(73) Assignee: COX COMMUNICATIONS, INC., Atlanta, GA (US)

(21) Appl. No.: 14/012,880

(22) Filed: Aug. 28, 2013

(51) Int. Cl. H04N 21/488; H04N 21/458; H04N 21/482

(52) U.S. Cl. CPC H04N 21/4882; H04N 21/482; H04N 21/458
USPC 725/46

(57) ABSTRACT

Systems and methods are disclosed for providing a program guide including scheduled and stored content items, indicating in the program guide where it has been determined that a match exists between stored and scheduled content items. In some embodiments, stored content information includes service provider stored content information and third party stored content information. Additionally, in some embodiments operations are performed on a set top box, service provider server, or a combination thereof.

### TECHNICAL FIELD

The present disclosure is generally related to electronic program guides and, more particularly, is related to an enhanced electronic program guide with an available duplicate content indicator.

### BACKGROUND

Electronic program guides are useful; however, such guides often inform the would-be viewer what they just missed. The viewer often discovers that they have failed to record their favorite program while browsing an electronic program guide roughly halfway into the now mostly missed program. For example, a viewer discovers an interesting program that started 50 minutes ago when looking through the electronic program guide on a DVR/set-top-box.

In order to check to see whether or not the same program (episode) will be shown again at a later time with existing systems, a viewer is required to navigate various menus and screen interfaces in order to scroll through upcoming shows in the electronic program guide. Additionally, if on-demand content is available, the viewer may check the listings of an on-demand service from their television service provider via more menus and interfaces, by exiting the scheduled program portion of the program guide and proceeding to an on-demand portion of the interface to determine whether or not the program is available for on-demand viewing.

Despite the ubiquity of cloud connected, media streaming devices, it is still possible for a viewer to miss their favorite television program. Conventional electronic program guides are limited to displaying what time a program will be shown. There are heretofore unaddressed needs with previous solutions.

### SUMMARY

Example embodiments of the present disclosure provide systems of notification of duplicate content available elsewhere. Briefly described, in architecture, one example embodiment of the system, among others, can be implemented as follows: a processor including a computer-readable medium with a set of instructions operable to: receive scheduled content data where the scheduled content data includes scheduled content items, receive stored content data where the stored content data includes a stored content items, determine that a stored content item matches a scheduled content item, and generate a program guide comprising the scheduled content data where at least one indicator is displayed next to each scheduled content item where it has been determined that a stored content item match exists.

Embodiments of the present disclosure can also be viewed as providing methods for notification of duplicate content available elsewhere. In this regard, one embodiment of such a method, among others, can be broadly summarized by the following steps: receiving scheduled content data where the scheduled content data includes scheduled content items, receiving stored content data where the stored content data includes stored content items, determining that a stored content item matches a scheduled content item, and generating a program guide comprising the scheduled content data where at least one indicator is displayed next to each scheduled content item where it has been determined that a stored content item match exists.

According to yet another embodiment of the present disclosure, a method for providing a program guide is provided including the steps of: receiving scheduled content information that includes a plurality of scheduled content titles and at least one scheduled content identifier associated with each scheduled content title, receiving stored content information that includes a plurality of stored content titles and at least one stored content identifier associated with each stored content title, determining that a stored content identifier matches a scheduled content identifier, and generating a program guide comprising the scheduled content information wherein at least one indicator is displayed next to each scheduled content title where it has been determined that a stored content identifier matches the scheduled content identifier.

### BRIEF DESCRIPTION OF THE DRAWINGS

FIG. 1 illustrates an exemplary environment in which an embodiment in accordance with the present disclosure may be practiced.

FIG. 2 illustrates an example system for supporting provision of an enhanced electronic program guide according to an example embodiment of the disclosure.

FIG. 3A schematically illustrates a conventional electronic program guide presented to a viewer.

FIG. 3B schematically illustrates a portion of an enhanced electronic program guide presented to a viewer in accordance with an example embodiment of the disclosure.

FIG. 4 schematically illustrates an enhanced electronic program guide presented to a viewer in accordance with an alternate example embodiment of the disclosure.

FIG. 5 schematically illustrates a program detail information screen presented to a viewer in accordance with an example embodiment of the disclosure.

FIG. 6 is a block diagram illustration of a method for providing an enhanced electronic program guide in accordance with an example embodiment of the disclosure.

FIG. 7 schematically illustrates local and third party sources of stored content information in accordance with an example embodiment of the disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the following description, numerous details are set forth to provide an understanding of the present disclosure. However, it will be understood by those of ordinary skill in the art that the present disclosure may be practiced without these details and that numerous variations or modifications from the described embodiments may be possible. The disclosure will now be described with reference to the figures, in which like reference numerals refer to like, but not necessarily the same or identical, elements throughout. For purposes of clarity in illustrating the characteristics of the present disclosure, proportional relationships of the elements have not necessarily been maintained in the figures.

Electronic program guides are generally provided to subscribers by a content service provider such as a cable television provider, a satellite television provider, or IP television provider. One method of creating an electronic program guide is illustrated in U.S. Publication No. 2011/0239251 to Miller entitled “Electronic Program Guide Generation” which is incorporated by reference herein.

According to one aspect of the disclosure, an enhanced electronic program guide is provided to the viewer to indicate in the electronic program guide that, in addition to the listed broadcast, or scheduled, showing time, one or more other options are available where the entire show can be viewed. By way of example, according to one embodiment of the disclosure, if the show is available “On Demand”, the guide shows an indicator next to the title of the show that has the “On Demand”, other applicable symbol, or abbreviated text. Another example, according to one embodiment of the disclosure, is to indicate if a program is available for viewing via a content provider website, a content provider application, or third party service provider application.

According to another example embodiment of the disclosure, an enhanced listing includes a visual indicator, such as an icon or text, next to the program title indicating that alternative means of accessing the show are available. According to another embodiment of the disclosure, the program detail information screen of the enhanced electronic program guide includes one or more hyperlinks/pointers for the user to access the content via/at the designated (alternate/duplicate) location.

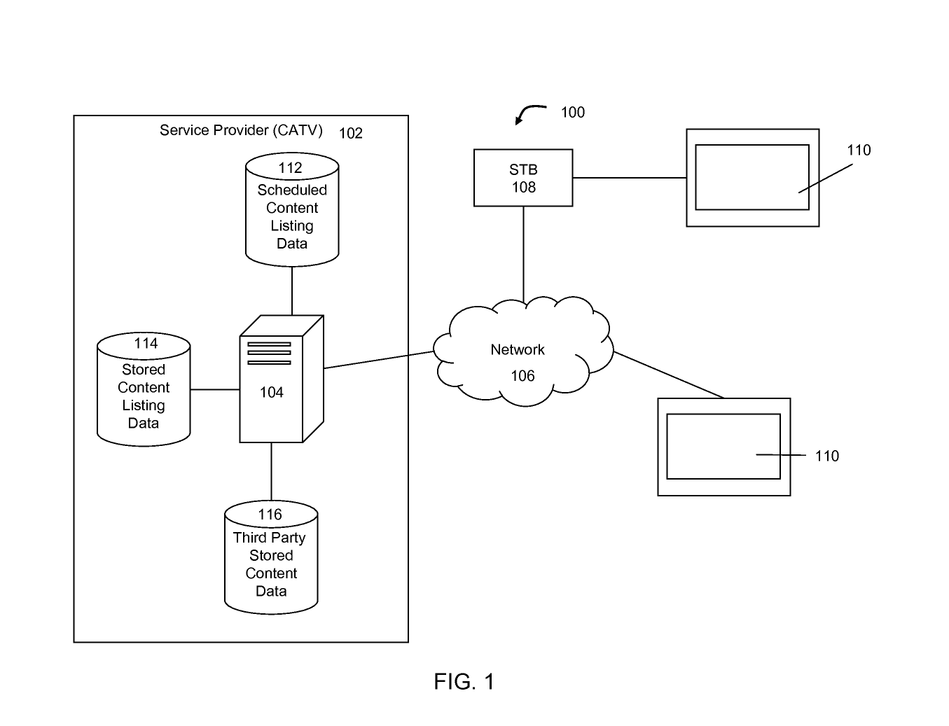

Referring now to the drawings in which like numerals represent like elements or steps throughout the several views, FIG. 1 is block diagram of exemplary environment 100 for providing an electronic program guide in accordance with the present disclosure. Exemplary environment 100 may comprise service provider 102, such as a Cable Television service provider (CATV), that includes service provider server 104 attached via network 106 to multiple data repositories including scheduled content listing data 112, stored content listing data 114, and third party stored content data 116.

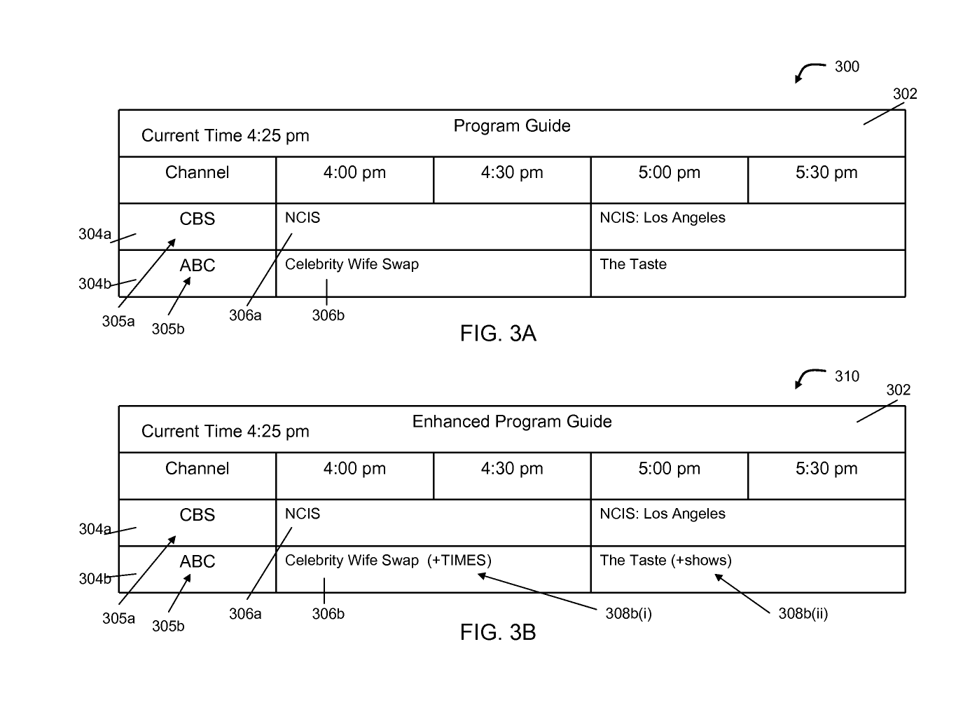

Content from service provider 102 may be transmitted for distribution over network 106 to Set Top Box (STB) 108 and one or more display devices 110. Content may either be sent directly to display device 110 or sent to STB 108 for use on display device 110. Examples of content include audio, video, and/or other data and/or signals and an electronic program guide as depicted in FIGS. 3A, 3B, 4, and 5.

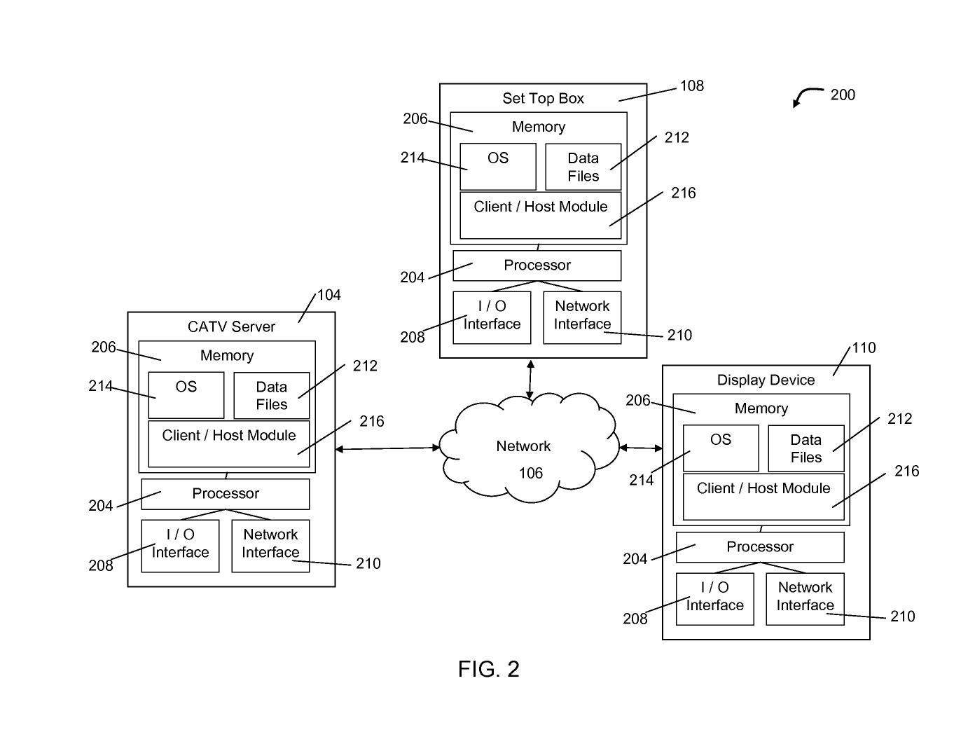

In an example embodiment, service provider server 104 may process and provide information from scheduled content listing data repository 112, stored content listing data repository 114, and third party stored content data repository 116 to generate electronic guide data associated with program content. Server 104 may include a graphics library associated with providing design information associated with layout, fonts, colors, and the like that are associated with the electronic program guide such as a carousel server. Service provider server 104 may comprise a computing device as described below with respect to FIG. 2. Consistent with embodiments of the disclosure, service provider server 104 may comprise one or more software applications (i.e., a series of instructions configured for execution by a processing unit) associated with another component, such as one or more servers or dedicated content devices.

Network 106 (also referred herein as distribution network or communication network) is, generally, used and implemented by a cable service provider (such as, but not limited to, a wired and/or wireless communication service provider) to enable the service provider to provide, and the service provider's subscribers to receive content and communication services. Network 106 additionally refers to infrastructure, including apparatuses and methods, operative and utilized to communicate data and/or signals between networked devices such as service provider server 104, STB 108, and display device 110. Similarly, for example and not limitation, network 106 may include current and future wired and/or wireless communication infrastructure for communicating video, audio, or other data and/or signals such as the public switched telephone communication network, cable and/or satellite telecommunications service provider communication networks, other service provider communication networks, and the Internet.

Additionally, network 106 may include any telecommunication and/or data network, whether public, private, or a combination thereof, including a local area network, a wide area network, an intranet, an internet, the Internet, intermediate hand-held data transfer devices, and/or any combination thereof and may be wired and/or wireless. Network 106 may also allow for real-time, off-line, and/or batch transactions to be transmitted between or among service provider server 104, STB 108, and display device 110. Due to network connectivity, various methodologies as described herein may be practiced in the context of distributed computing environments.

Although STB 108 is shown for simplicity in an example embodiment as being in communication with service provider server 104 via one intervening network 106, it is to be understood that other network configurations may be used. For example, intervening network 106 may include a plurality of networks, each with devices such as gateways and routers for providing connectivity between or among networks. Instead of, or in addition to network 106, dedicated communication links may be used to connect the various devices in accordance with example embodiments of the disclosure. For example, STB 108 may form the basis of network 106 that interconnects one or more display devices 110.

As shown in FIG. 1, service provider 102 components including service provider server 104, STB 108, and display device 110 may be in communication with each other via a network such as network 106, which as described herein can include one or more separate or shared private and public networks, including the Internet or a publicly switched telephone network. STB 108 may include a stand alone or integrated devices such as a pc, media server, television tuner, satellite or cable receiver, digital video recorder, video game console, Blu-ray player, tablet, smart device, and the like. Display device 110 may include one or more of video playback screen, tablet device, smart phone, PDA, or other device with one or more connectivity options. Display device 110 may also include LCD display devices such as a monitor featuring an operating system, media browser, and the ability to run one or more software applications. Display device 110 may also include the same features and functionality of STB 108.

Service provider server 104 is shown in communication with multiple data repositories including scheduled content listing data 112. It will be appreciated that the terms broadcast, scheduled, and linear are used interchangeably herein as applied to content. It will further be appreciated that content, television program, show, movie, video, audio, picture and the like are used interchangeably herein as well. By way of example and not limitation, scheduled content listing data may include program title, episode number, running length, channel, date, start time, ratings, and synopsis summary. Scheduled content listing information may be stored in any computer readable form. Additionally, it will be appreciated those of ordinary skill in the art that scheduled content program information may include information guide data from one or more sources such as obtaining guide data from Tribune Media Services.

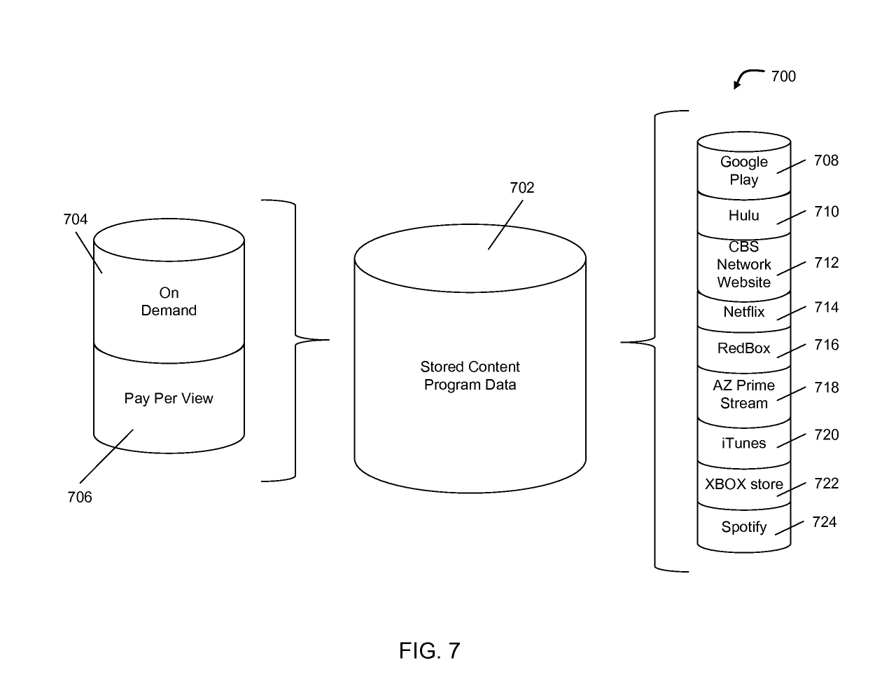

With respect to stored content information, such as the information in stored content listing data repository 114 or third party stored content data repository 116, stored content refers to media that is capable of being streamed or otherwise requested as opposed to being broadcast at a scheduled time via one or more channels. Stored content may include on-demand programs and pay per view shows. Third party stored content information, such as may be stored in third party stored content data 116, includes location and availability information for shows that are capable of being streamed or otherwise requested via third party content provider such as a movie streaming subscription service or other like content providers set forth in more detail in FIG. 7. By way of example and not limitation, stored content listing data may include program title, episode number, running length, channel, date, start time, ratings, synopsis, in addition to content location, pricing, application link, etc.

FIG. 2 illustrates an example system 200 for supporting provision of an electronic program guide according to an example embodiment of the disclosure. Service provider server 104, STB 108, and display device 110 may be any processor-driven device, such as, but not limited to, a personal computer, laptop computer, handheld computer, dedicated processing device, and/or an array of computing devices. In addition to having processor 204, server 104, STB 108, and display 110 may further include memory 206, input/output (“I/O”) interface(s) 208, and network interface 210. Memory 206 may be any computer-readable medium, coupled to the processor, such as RAM, ROM, and/or a removable storage device for storing data files 212 and a database management system (“DBMS”) to facilitate management of data files 212 and other data stored in memory 206 and/or stored in separate databases. Memory 206 may store data files 212 and various program modules, such as operating system (“OS”) 214 and client module 216. OS 214 may be, but is not limited to, Microsoft Windows®, Apple OSX™, Unix, Linux, Android, or a mainframe operating system. Client module 216 may be an Internet browser or other software, including a dedicated program, for interacting with server 104, network 106, STB 108, and/or display device 110.

Suitable processors, such as processors 204 of service provider server 104, STB 108, and display device 110, respectively, may comprise a microprocessor, an ASIC, and/or a state machine. Example processors may include those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein.

Generally, each of the memories and data storage devices, such as memories 204 and databases 112, 114, 116 (as shown in FIG. 1), and/or any other memory and data storage device, can store data and information for subsequent retrieval. In this manner, systems can store various received or collected information in memory or a database associated with service provider server 104, STB 108, and/or display device 110. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

As used herein, the term “computer-readable medium” may describe any form of memory or a propagated signal transmission medium. Propagated signals representing data and computer program instructions may be transferred between network devices and systems. Embodiments of computer-readable media include, but are not limited to, electronic, flash, optical, magnetic, or other storage or transmission device capable of providing a processor with computer-readable instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Generally, network devices and systems, service provider server 104, STB 108, and display device 110 have hardware and/or software for transmitting and receiving data and/or computer-executable instructions over a communications link and a memory for storing data and/or computer-executable instructions. These network devices and systems may also include a processor for processing data and executing computer-executable instructions locally and over network 106, as well as other internal and peripheral components that are well known in the art.

Still referring to service provider server 104, STB 108, and display 110, the I/O interface(s) 208 may facilitate communication between the processor 204 and various I/O devices, such as a keyboard, mouse, printer, microphone, speaker, monitor, bar code readers/scanners, RFID readers, and the like. Network interface 210 may take any of a number of forms, such as a network interface card, a modem, a wireless network card, and the like. It will be appreciated that while service provider server 104, STB 108, and display 110 have been illustrated as a single computer or processor, the service provider server 104, STB 108, and display 110 may be comprised of a group of computers or processors, according to an example embodiment of the disclosure.

As previously mentioned, network 106 may takes many forms, including a public and/or a private network, such as a cable television distribution network (e.g., a hybrid fiber-coax network), a cellular data network, a metropolitan WiMAX network, and/or the Internet.

Exemplary environment 100 shown in and described with respect to FIGS. 1 and 2 are provided by way of example only. Numerous other operating environments, system architectures, and device configurations are possible. Other system embodiments can include fewer or greater numbers of components and may incorporate some or all of the functionality described with respect to the system components shown in FIGS. 1 and 2.

For example, in one embodiment, service provider server 104 (or STB 108/display device 110) may be implemented as a specialized processing machine that includes hardware and/or software for performing the methods described herein. In addition, the processor and/or processing capabilities of service provider server 104, may be implemented as part of STB 108, display device 110, or any portion or combination thereof. Accordingly, embodiments of the disclosure should not be construed as being limited to any particular operating environment, system architecture, or device configuration.

FIG. 3A is an illustration of an example embodiment of conventional electronic program guide 300. Conventional electronic program guide 300 may be provided by CATV service provider 102, and will only show scheduled content listing information. As shown, guide 300 includes heading row 302 and a multiple channel information rows 304a-b. Each of channel information rows 304a-b features a channel identifier 305a-b and program and schedule information, such as a program content entry 306a-b. Channel identifier 304 may comprise a physical and/or a virtual channel number (e.g., the channel number a viewer may input into STB 108 and/or one of display device 110 to tune to that channel). Program content entry 306a-b includes information associated with the program such as a title, actors, genre, episode description, and/or duration.

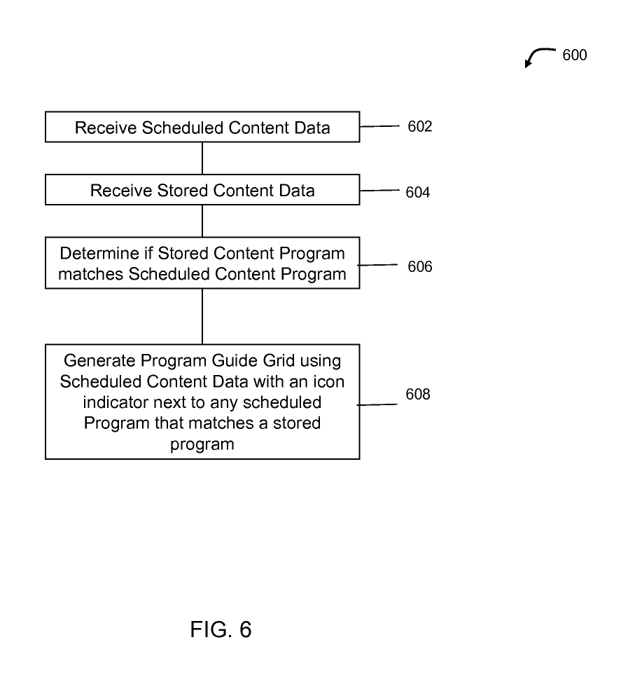

FIG. 3B is an illustration of an example embodiment of enhanced electronic program guide 310 presented to a viewer in accordance with an embodiment of the disclosure. Unlike, conventional program guide 300, enhanced program guide 310 includes information from both the scheduled content listings and information from stored content listings when a content match has been determined in the manner described in FIG. 6. Enhanced program guide 310 features heading row 302, channel information rows 304a-b, and channel identifiers 305a-b. As shown, each of channel information rows 304a-b display a channel identifier 305a-b and program and schedule information, such as a program content entry 306a-b. Program content entry 306a-b shows information associated with the content such as a title, actors, genre, episode description, and/or duration. Program content entry 306a-b may be formatted with font and/or color information, such as by assigning a background color according to a genre of the content.

As shown in FIG. 3B, indicators 308b(i) and 308b(ii) are present next to the scheduled program titles 306a-b shown in enhanced guide 310 to inform the viewer that additional instances of “Celebrity Wife Swap” and “The Taste” are available for viewing. While indicator 308b(i) reads “(+TIMES)” and indicator 308b(ii) reads “(+shows)”, other sorts of indicators such as an icon, abbreviation, highlighting, or changes in font or background color may be used to indicate that duplicate instances exist for alternate or later viewing.

According to another example embodiment of the disclosure, an enhanced listing includes a visual indicator, such as an icon or text, next to program listing where alternative means of accessing the show are available. According to another example embodiment of the disclosure, the program detail information screen of the enhanced electronic program guide includes one or more hyperlinks/pointers for the user to access the content via/at the designated (alternate/duplicate) location.

According to yet another example embodiment of the disclosure, a viewer walks in and sees that a show is already halfway into a one hour program that the viewer did not record. The viewer sees from the enhanced program guide screen that there are additional ways to access the program in question.

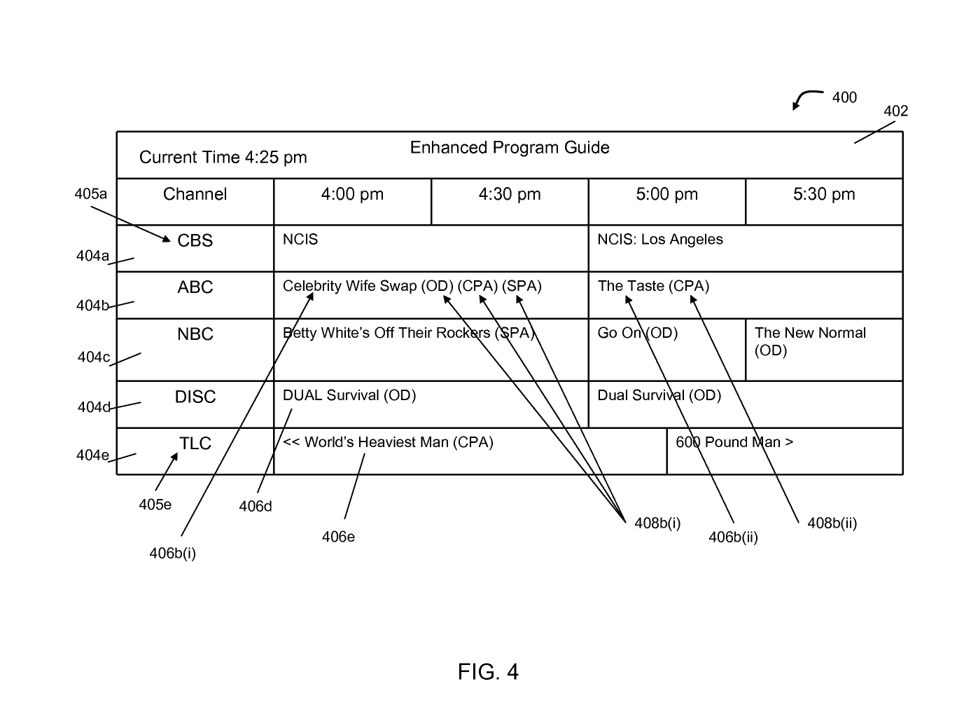

FIG. 4 illustrates an example embodiment of enhanced electronic program guide 400 presented to a viewer in accordance with the present disclosure. As discussed, guide 400 includes heading row 402 and several channel information rows 404a-e. Each of channel information rows 404a-e shows channel identifier 405a-e in addition to program and schedule information, such as a program content entries 406b(i) and 406b(ii). Program content entries 406b(i) and 406b(ii) may be formatted with font and/or color information, such as by assigning a background color according to a genre of the content.

Enhanced program guide 400 includes information from both scheduled content listings and information from stored content listings when a content match has been determined in the manner described in FIG. 6. As shown in FIG. 4, indicators 408b(i) and 408b(ii) are present next to the scheduled program titles 406b(i) and 406b(ii), respectively, shown in enhanced guide 400 to inform the viewer that additional instances of “Celebrity Wife Swap” and “The Taste” are available for viewing.

While, as shown in FIG. 3B, indicator 308b(i) read “(+TIMES)” and indicator 308b(ii) read “(+shows)”, the embodiment of the enhanced guide 400 shown in FIG. 4 uses “(OD) (CPA) (SPA)” as non-limiting examples for indicator 408b(i) and “(CPA)” for indicator 408b(ii). OD is an abbreviation to inform the viewer that “Celebrity Wife Swap” is also available for viewing “on-demand” in addition to the scheduled broadcast time. CPA stands for Content Provider Application, and SPA stands for Service Provider Application. As discussed, other types of indicators such as an icon, abbreviation, highlighting, or changes in font or background color may be used to indicate that duplicate instances exist for alternate or later viewing.

According to another example embodiment of the disclosure, an enhanced program guide presents the viewer with a visual indication next to the program title that the desired program will be shown (repeated/re-aired) again on the same channel later in the same evening.

According to yet another example embodiment of the disclosure, a viewer sees that a show is already halfway into a one hour program that the viewer did not record. The viewer sees from the enhanced program guide screen 310 or 400 that there are additional ways to access the program in question.

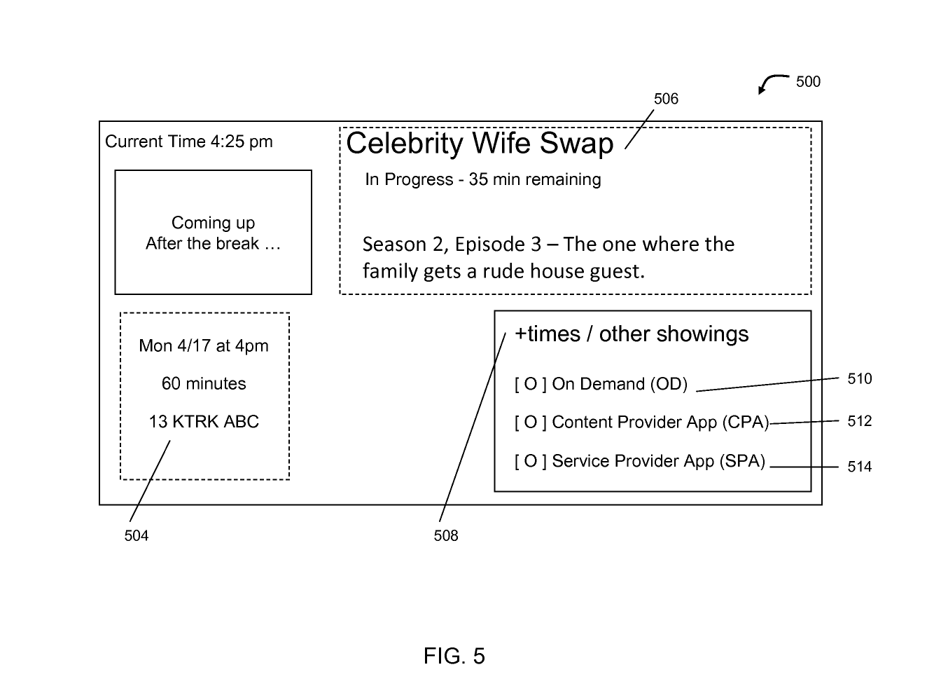

FIG. 5 schematically illustrates a program detail information screen 500 presented to a viewer in accordance with an example embodiment of the disclosure. As shown, channel information 504 along with program content information 506 which may include program title, time remaining, series, episode number and synopsis. As depicted by duplicate indicator 308b(ii) of FIG. 3B and duplicate indicators 408b(i) of FIG. 4, availability listing 508 shows that the program is also available for viewing on-demand 510 in addition to via a content provider app 512, and via service provider app 514.

Exemplary content provider applications 512 include browsers, media players, or dedicated applications that are capable of playing back the stored content. Such applications may include a player with the capability of playing multiple media types and media codecs including Adobe Flash, Microsoft Silverlight, MPEG, or HTML5. Additionally, codecs used by content provider application 512 may include appropriate digital rights management features. Examples of dedicated applications include applications such as the Netflix Player and Amazon Prime Video player applications presently available on smart televisions, Blu-ray players, and gaming consoles such as the Microsoft XBOX. Exemplary service provider applications 514 include one or more, or a combination of one of more content provider applications 512, open source, or proprietary applications capable of media playback as well as applying any relevant subscription service fees for viewing stored content.

FIG. 6 is a block diagram illustration of instructions 600 for providing an enhanced electronic program guide in accordance with an example embodiment of the disclosure. In block 602, scheduled content data is received. In block 604, stored content data is received. In block 606, a determination is made to see if a stored content program matches a scheduled content program. At least one example method of determining stored content matches is illustrated in U.S. Publication No. 2012/0233138 to Aspinwall entitled “Assigning a Single Master Identifier to All Related Content Assets” which is incorporated by reference herein. In block 608, a program guide is generated listing the scheduled content data. Additionally, an indicator is displayed next to the title of any scheduled program for which it has been determined that there is a match in the stored content data as performed in block 606.

It will be appreciated by one of ordinary skill in the art that the steps/instructions set forth in FIG. 6 may be performed on service provider server 104, STB 108, or display device 110. Additionally, it should be noted that stored content data information may include both data stored or within the domain of service provider 102 and third party service provider stored content data that is available by virtue of a viewer's third party content subscription.

Additionally, it will be appreciated that there are numerous ways to determine whether or not there is a match between scheduled content items and stored content items. Such techniques include matching program titles, season and episode numbers, generating a unique hash, generating a content identifier or using/matching a combination of program content listing information. For example, a content identifier may include one or a combination of: a program title, episode number, and season number. It will be appreciated that a content identifier may include as much or as little relevant program listing information as may be used to determine whether or not a stored content item matches a scheduled content item. Additionally, temporary lookup tables may be generated to match program information depending on the variability, completeness, and accuracy of content information sources.

FIG. 7 schematically illustrates possible sources of stored content information 700 in accordance with an example embodiment of the disclosure. Item 702 represents a stored content data repository such as stored content listing data repository 114 or third party stored content data repository 116 as shown in FIG. 1. It is contemplated by example embodiments of the present disclosure that stored content program data include information from stored content sources such as On Demand 704 and Pay Per View 706 content listing information. According to further embodiments of the present disclosure, third party stored content information may include both paid and free sources. By way of example and not limitation, third party sources include Google Play 708, Hulu 710, CBS Network Website 712, Netflix Streaming 714, RedBox 716, Amazon Prime Video 718, iTunes Store 720, XBOX store 722, and Spotify 724. It will be appreciated that other third party sources may be configured according to viewer preferences as well, such as accessing a public or university library media service.

The flow chart of FIG. 6 shows the architecture, functionality, and operation of a possible implementation of providing an enhanced program guide. In this regard, each block represents a module, segment, or portion of code, which comprises one or more executable instructions for implementing the specified logical function(s). It should also be noted that in some alternative implementations, the functions noted in the blocks may occur out of the order noted in FIG. 6. For example, two blocks shown in succession in FIG. 6 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

1. A method for providing a program guide, the method comprising:
receiving scheduled content information that includes a plurality of scheduled content titles and at least one scheduled content identifier associated with each scheduled content title;
receiving content information that includes at least one duplicate content title scheduled at at least one of a later time or on a different channel or available through an on demand service and at least one duplicate content identifier associated with each duplicate content title;
determining that a duplicate content identifier matches a scheduled content identifier; and
generating an electronic program guide comprising the scheduled content information wherein at least one indicator is displayed next to each scheduled content title where it has been determined that a duplicate content identifier matches the scheduled content identifier.

2. The method of claim 1, wherein the at least one indicator designates the location of the matching duplicate content title.

3. The method of claim 1, further comprising the step of graphically highlighting each scheduled content title where it has been determined that a duplicate content identifier matches the scheduled content identifier.

4. The method of claim 1, wherein the duplicate content information includes service provider content information and third party content information.

5. The method of claim 1, wherein one or more of the steps are performed on a service provider server.

6. The method of claim 1 wherein one or more of the steps are performed on a set top box.

7. A system for providing a program guide, comprising:
a processor comprising a tangible computer-readable medium with a set of instructions operable to:
receive scheduled content data wherein the scheduled content data includes a plurality of scheduled content items;
receive duplicate content data wherein the duplicate content data includes at least one content items titles item scheduled at at least one of a later time or on a different channel or available through an on demand service;
determine that a duplicate content item matches a scheduled content item; and
generate an electronic program guide comprising the scheduled content data wherein at least one indicator is displayed next to each scheduled content item where it has been determined that a duplicate content item match exists.

8. The system of claim 7, wherein the at least one indicator designates the location of the matching stored content title.

9. The system of claim 7, wherein the computer-readable medium comprises a set of instructions further operable to: graphically highlight each scheduled content title where it has been determined that a duplicate content identifier matches the scheduled content identifier.

10. The system of claim 7, wherein the duplicate content information includes service provider duplicate content information and third party duplicate content information.

11. The system of claim 7, wherein one or more of the instructions are performed on a service provider server.

12. The system of claim 7, wherein one or more of the instructions are performed on a set top box.

13. A method for providing a program guide, the method comprising:
receiving scheduled content data wherein the scheduled content data includes a plurality of scheduled content items;
receiving duplicate content data wherein the duplicate content data includes at least one duplicate content item scheduled at at least one of a later time or on a different channel or available through an on demand service;
determining that a duplicate content item matches a scheduled content item; and
generating an electronic program guide comprising the scheduled content data wherein at least one indicator is displayed next to each scheduled content item where it has been determined that a duplicate content item match exists.

14. The method of claim 13, wherein the at least one indicator designates the location of the matching duplicate content title.

15. The method of claim 13 further comprising the step of graphically highlighting each scheduled content title where it has been determined that a duplicate content identifier matches the scheduled content identifier.

16. The method of claim 13, wherein the duplicate content information includes service provider duplicate content information and third party duplicate content information.

17. The method of claim 13, wherein one or more of the steps are performed on a service provider server.

18. The method of claim 13 wherein one or more of the steps are performed on a set top box.
